(19) United States
(12) Patent Application Publication
(10) Pub. No.: US 2008/0159532 A1
(43) Pub. Date: Jul. 3, 2008

(54) Architecture for supporting high definition content protection decryption over high definition multimedia interface links

(76) Inventor: Rohit R. Verma, San Jose, CA (US)

Correspondence Address: TROP PRUNER & HU, PC, 1616 S. VOSS ROAD, SUITE 750, HOUSTON, TX, 77057-2631, US

(21) Appl. No.: 11/648,407

(22) Filed: Dec. 29, 2006

(51) Int. Cl. H04N 7/167

(52) U.S. Cl. 380/210

(57) ABSTRACT

In one embodiment, the present invention includes a method for receiving a first encrypted data stream in a cipher, receiving parsed condition information in a first state machine, where the parsed condition information corresponds to the first encrypted data stream, and decrypting the first encrypted data stream in the cipher responsive to control of the first state machine based on the parsed condition information. Other embodiments are described and claimed.

### BACKGROUND

A High Definition Multimedia Interface (HDMI) in accordance with the HDMI specification version 1.3 (published Jun. 22, 2005) is used for transferring uncompressed video and audio data between, for example, set-top boxes or digital versatile disk (DVD) players and display devices such as digital televisions. HDMI is based on digital video interface (DVI) technology, but provides a much smaller and flexible solution. It is capable of replacing up to eight audio cables and up to five video cables with a single cable. Widespread adoption of HDMI-enabled televisions and monitors is expected to continue.

The HDMI specification calls out for audio and video data to be protected as per the High-Bandwidth Digital Content Protection System (HDCP) Revision 1.1 (published Jun. 9, 2003). A HDMI sink is given device specific keys. Sinks use these keys to authenticate with a HDMI source and decrypt incoming audiovisual (AV) data over the HDMI interface. Typically the logic and circuitry associated with encryption/decryption can be complex and cost and area intensive.

### BRIEF DESCRIPTION OF THE DRAWINGS

FIG. 1 is a block diagram illustrating a system in accordance with one embodiment of the present invention.

FIG. 2 is a block diagram of an interface in accordance with one embodiment of the present invention.

FIG. 3 is a flow diagram of a method in accordance with one embodiment of the present invention.

### DETAILED DESCRIPTION

Architectures in accordance with an embodiment of the present invention support HDCP over an HDMI interface. The HDCP specification outlines sink requirements to ensure robust security of the HDMI interface. The partitioning of logic functions and a core cipher in accordance with an embodiment of the present invention enables easy reuse of cipher hardware, software and/or firmware (e.g., a cipher code base) while meeting these requirements of the specification.

Embodiments may enable a reuse capability. That is, HDMI sources and sinks have very similar functions with respect to HDCP. The core cipher transformation functions are same for both, but the state machines and use of this cipher differs. Embodiments may partition the HDCP logic functions in a way that allows easy reuse of the cipher code. Embodiments may further be scaled to handle multiple HDMI streams. The bulk of the area in a HDCP implementation comes from key storage and the cipher logic. This architecture allows a use case where the cipher can be used by more than one stream handling state machine, and thus the key storage and cipher area need not be duplicated for multiple streams.

Embodiments may also enable achievement of power conservation goals. With this logic partitioning, aggressive power saving techniques may be implemented. For example, when an unencrypted stream is being received, the complete HDCP subsystem can be clock gated, and a single stage in the data path can be clocked to pass data to downstream logic. Further, in cases when the same cipher is used to support multiple streams, the idle state machine (within the cipher module) and the cipher itself can be clock-gated. Besides this, while encrypted streams are being received, parts of idle logic can be clock gated. Data parsing and condition detection is done outside the sub-system and idle logic can be identified, leading to intelligent power conservation.

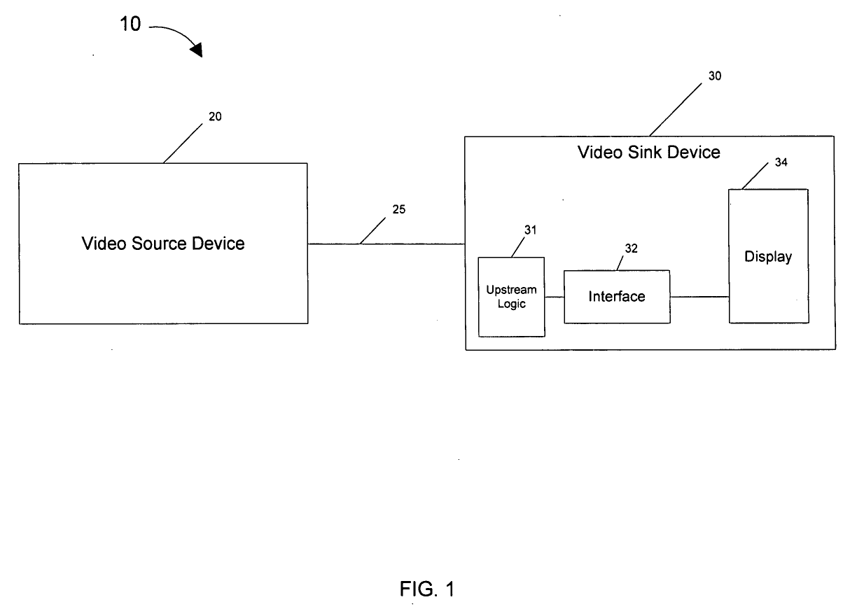

Referring now to FIG. 1, shown is a block diagram illustrating a system in accordance with one embodiment of the present invention. As illustrated, a video source device 20 and a video sink device 30 are coupled to each other by digital video link 25. Video source device 20 provides video content to video sink device 30 through digital video link 25. Video content may be provided in a ciphered digital form from video source device 20 to video sink device 30 through video link 25, making it more difficult to pirate video content during transmission.

Video source device 20 and video sink device 30 are both intended to represent a broad range of such devices known in the art. Examples of video source devices include but are not limited to computers of all sizes (from palm size devices to desktop devices, and beyond), set-top boxes, or DVD players, whereas examples of video sink devices include but are not limited to cathode ray tubes (CRT) monitors, flat panel displays or television sets, such as a high definition television (HDTV). Digital video link 25 may be implemented in any one of a number of mechanical and electrical forms, as long as they are consistent with the operating requirement (i.e., speed, bit rate and so forth), and a mechanism (which may be in hardware or through protocol) is provided to allow control information to be exchanged between video source and sink devices 20 and 30 (hereinafter, simply source and sink devices respectively).

After authentication of a sink device 30, source device 20 ciphers video content into a ciphered form before transmitting the video content to sink device 30. Upon receipt of the video content in ciphered form, sink device 30 deciphers the ciphered video content, e.g., via an upstream logic 31 which may parse out control information, which it provides along with stream data to an interface 32 for decryption, and the unencrypted data is provided to, e.g., a display 34.

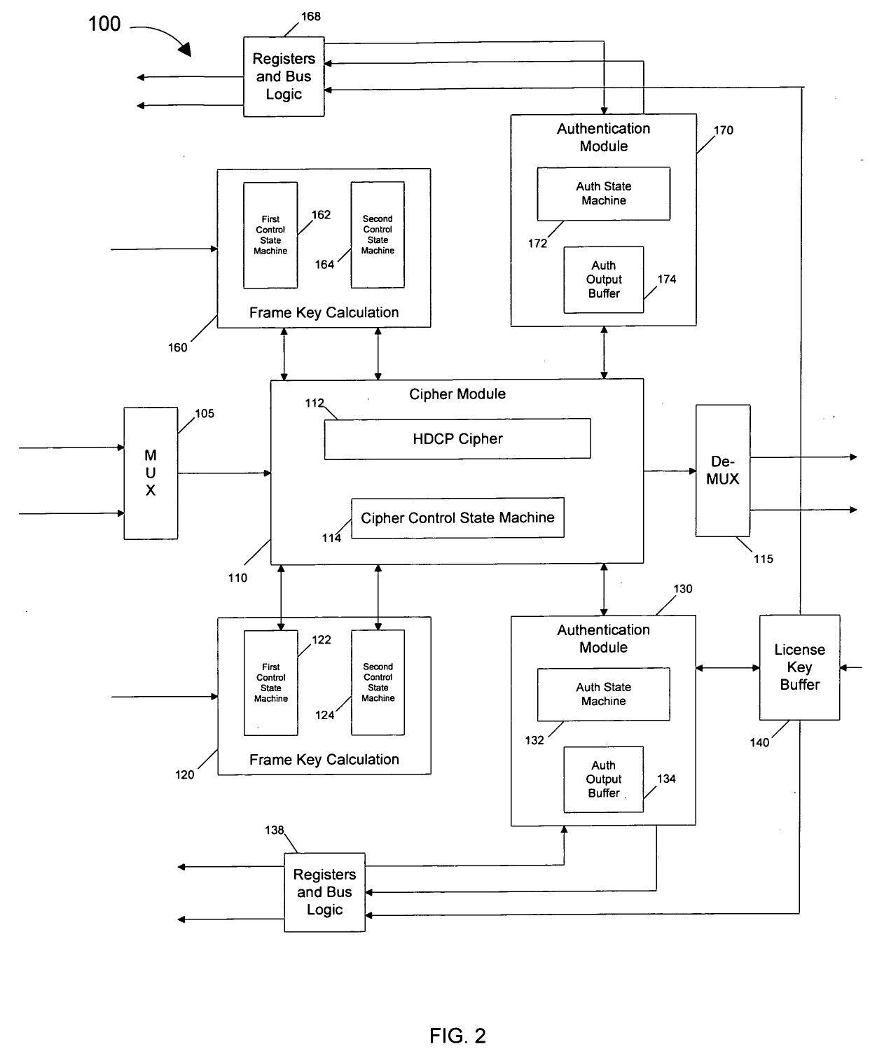

Referring now to FIG. 2, shown is a block diagram of an interface in accordance with one embodiment of the present invention. More specifically, FIG. 2 shows an HDCP subsystem, i.e., interface 100 that may be present in a video sink device, such as video sink device 30 of FIG. 1. The microarchitecture of interface 100 may enable significant logic reuse such that multiple sources may be supported using a minimal amount of hardware. Furthermore, the architecture may partition HDCP logic functions to allow reuse of cipher functionality. Cipher functionality may support multiple streams, e.g., from different sources and furthermore may be readily reused in various architectures including in other sink architectures, as well as reuse in source architectures.

As shown in FIG. 2, interface 100 may include a cipher module 110 that includes a HDCP cipher 112 to perform transformation functions and a cipher control state machine 114. In the embodiment shown in FIG. 2, cipher control state machine 114 may be one or more finite state machines (FSM) that may perform in various modes including, for example a block mode, a re-key mode, and a stream cipher mode. In addition, multiple dedicated FSMs may be present for controlling operation of cipher 112 in various modes for different incoming data streams, e.g., of different encryption capabilities, authentication operations and so forth.

As shown in FIG. 2, cipher module 110 may be coupled to an input multiplexer 105 that may be adapted to receive incoming data, e.g., encrypted AV data from various sources. In the embodiment shown in FIG. 2, two such sources may be present, however the scope of the present invention is not so limited in this regard. In general, encrypted data may be passed through multiplexer 105 and be provided to cipher module 110 for ciphering. The deciphered data may then be provided to a de-multiplexer 115 which may provide decrypted data to one of various sources, e.g., a display such as a HDTV display, another display or storage, or other sources. Ciphering of encrypted data may be performed in cipher module 110 pursuant to instructions and information from both authentication module 130 and frame key calculation module 120, as well as similar information from frame key calculation module 160 and authentication module 170.

As shown in FIG. 2, frame key calculation module 120 may include multiple state machines, e.g., FSMs, including a first state machine 122, which may be an enhanced encryption status signaling (EESS) control state machine and a second state machine 124, which may be an original encryption status signaling (OESS) control state machine. Using these state machines, frame key calculation module 120 may perform frame key calculations responsive to incoming signals, e.g., from a given source. Such signals may include horizontal and vertical synchronization signals (HSYNC and VSYNC, respectively) as well as encoding signals and other flags. Authentication module 130 may be used to perform an authentication of interface 100, and more particularly to perform authentication of a sink in which interface 100 is included via an authentication state machine 132, which may be a FSM. Authentication module 130 is coupled to a license key buffer 140. License key buffer 140 may be coupled to receive license keys over a secure channel. In turn, authentication module 130 may include an authentication output buffer 134 that may be coupled to registers and bus logic 138 (hereafter, logic 138) which in one embodiments may include control and status registers (CSRs) and I²C (inter-integrated circuit bus) logic. Various authentication information may be communicated between logic 138, authentication module 130, license key buffer 140 and one or more devices to which interface 100 may be coupled, e.g., one or multiple sources of encrypted data. Accordingly, logic 138 may include an I²C interface and a CSR interface to communicate with such sources. In turn, logic 138 may provide an authentication request to authentication module 130. Responsive to such a request, authentication module 130 may provide various authorization data values, including R′₀ to digital data channel (DDC) control, as well as status registers. Similarly, license key buffer 140 may provide certain information including, for example a KSV value to a digital data channel (DDC) control within logic 138.

License key buffer 140 may be used to hold the “secure keys” assigned to each device. In one embodiment, authorization output buffer 134 may be populated within interface 100 in a secure manner that ensures confidentiality of the device private keys. Authentication module 130 may be responsible for authenticating interface 100 with a video source. Interface 100 receives an authentication request over a DDC channel. This DDC channel may use the I² C protocol and electricals for communication and signaling.

Authentication module 130 provides an authentication state machine 132 and an authentication output buffer 134. Authentication state machine 132 may be a state machine that responds to an authentication request and may adhere to performance requirements specified by the HDCP specification.

On receiving an authentication request, authentication state machine 132 uses the device private keys and cipher 112 to calculate multiple values. Some of these values (e.g., Ro, Ri, Pj) may be provided to a source as part of the authentication process. Frame key calculation module 120 may be used to perform frame key calculations. A video source may signal interface 100 to begin the third part of the authentication protocol through control (CTL0-3) signals. Two different protocols for signaling may be supported, namely OESS and EESS. The ESS decision occurs prior to authentication. HDCP sources assume use of the DVI protocol and OESS in the initial states. A source may then determine the sink's capabilities and make a decision if EESS can be used. In an overall source unit, there are upstream modules that parse through the incoming data and set some flags. These flags are passed to interface 100 along with AV data.

First control state machine 122 and second control state machine 124 implement OESS or EESS behavior as per the HDMI specification. One of these state machines is triggered based on the mode (HDMI or DVI) and CSR setting by software. Based on this decision, the active state machine changes state on every active vertical synchronization signal (VSYNC), calculates the frame key for every new frame (or field) and clocks cipher module 110 to keep it ready for incoming AV data. Note that these functions may be partitioned. In various embodiments, these state machines do not parse incoming data, and do not perform decisions like encoding enabled or data determinations (e.g., VideoData or AudioData). Instead these state machines rely on upstream logic to make these decisions. In this way, validation may be eased because different logic pieces can be stressed independently.

Cipher module 110 may include multiple logic layers that each performs specific functions. Different combinations of these functions may lead to different modes. The modes are requested by authentication or frame key calculation modules 130 and 120. Cipher module 110 responds to their requests by running the cipher for specified clocks with supplied initialization values. Cipher module 110 may include cipher control state machine 114. FSM 114 may receive requests from Authentication or the first and second state machines. These requests instruct FSM 114 to go into one of the 3 modes, block, rekey, or stream cipher, and clock the cipher for a specified number of cycles. FSM 114 decides the initialization values of the cipher and captures cipher outputs after predetermined steps.

Interface 100 is partitioned into logical modules. In this way OESS/EESS state machines may be readily implemented. That is, the HDCP specification outlines the state transitions on specific input conditions, which can be implemented in silicon. With this architecture, cipher 112 may be isolated as a separate logic function. In the embodiment of FIG. 2, cipher 112 may be an implementation of the functions defined in the HDMI specification. Thus, cipher module 110 may respond to simple commands in every cycle. These functions are the same for both a receiver and a transmitter. Thus a cipher in accordance with an embodiment of the present invention can be used in source implementations. Still further, the interface 100 may be reusable in another sink device. The architecture depends on supporting logic that parses incoming data and sets condition flags, as such as synchronization and encoding enable/disable flags, which are detected outside of interface 100. As a result, there can be multiple ways of recovering this information from the incoming stream. Interface 100 may output 24 bits of unencrypted AV data and clean intermediate values in one embodiment of the present invention, as defined in the specification. In cases of incoming unencrypted data, cipher 112 may be clock gated and a data path may provide the data directly from multiplexer 105 to de-multiplexer 115. Thus even if a different product implements an HDMI unit in a different architecture, interface 100 can be reused within that architecture.

Embodiments may also lend themselves to scalable solutions. For a particular device, the keys are unique. Embodiments can use the same set of keys to authenticate multiple sources in parallel. Also, the cipher calculations remain the same. Thus, to support multiple HDMI streams, an interface can be scaled for that implementation, and the main area contributing modules need not be duplicated. That is, to achieve scalability, only the authentication and first and second state machines are duplicated (e.g., via frame key calibration module 160 with FSMs 162 and 164, authentication module 170 with FSM 172 and buffer 174, and logic 168), as these state machines are stream specific, and the multiple duplicate state machines can use cipher 112 for stream specific operations. For such a solution, cipher 110 may be clocked at a higher speed than the rest of the state machines. For example, the maximum incoming rate of one HDMI stream is 165 megahertz (MHz), while cipher 110 may be set at double that rate.

By partitioning of the logic as described above, a cipher in accordance with an embodiment of the present invention may be reused or ported across different product lines. That is, a common cipher can be used across different devices of a product line. Such products can include various source, sink, and repeater devices. In contrast, a more straight forward approach would merge the different functions and detection logic, as it is easier to parse HDMI streams at the same stage as HDCP decryption and further, the HDCP state machines are also very inter-dependent. Thus, an easier design approach would be to reduce the number of FSMs, and reduce the complexity of dependent state machines. However, such an approach would not allow easy reuse and scalability. Thus embodiments may provide a robust, reusable and scalable implementation that meets aggressive power goals.

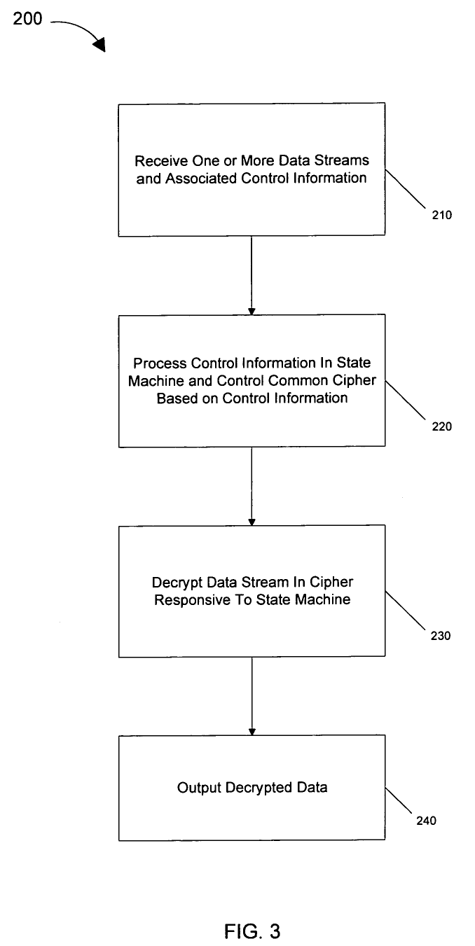

Referring now to FIG. 3, shown is a flow diagram of a method in accordance with one embodiment of the present invention. As shown in FIG. 3, method 200 may be used to handle one or more incoming data streams that may include encrypted data in an interface in accordance with an embodiment of the present invention. Method 200 may begin by receiving one or more data streams and associated control information with such data streams including, for example, synchronization information, encryption status, and so forth that may have been parsed ahead of the interface (all block 210). More specifically, the data streams may be provided to a cipher, while the control information may be provided to one or more FSMs such as may be present in frame key calculation modules. Note that for each data stream, associated control information may be provided to a separate FSM.

Still referring to FIG. 3, this control information may be processed in the associated state machine, and the cipher that receives the data, which may be a common cipher, may be controlled based on the control information processed by the FSM (block 220). Then the one or more data streams may be decrypted in the cipher responsive to the state machine control (block 230). Finally, decrypted data, which may correspond to decrypted AV data, may be output (block 240). While shown with this particular limitation in the embodiment of FIG. 3, the scope of the present invention is not limited in this regard.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a first encrypted data stream in a cipher;
receiving first control information in a first state machine, the first control information comprising parsed condition information corresponding to the first encrypted data stream; and
decrypting the first encrypted data stream in the cipher responsive to control of the first state machine based on the parsed condition information.

2. The method of claim 1, further comprising:
receiving a second encrypted data stream; and
decrypting the second encrypted data stream responsive to control of a second state machine associated with the second encrypted data stream in the cipher, the cipher comprising a common cipher, wherein the common cipher is reusable in different devices of a product line.

3. The method of claim 2, further comprising operating the common cipher at a higher bandwidth than the first state machine and the second state machine.

4. The method of claim 1, further comprising selecting one of a plurality of modes for the cipher responsive to control of one of the first state machine, a second state machine, and a third state machine.

5. The method of claim 1, wherein the parsed condition information comprises control flags associated with the first encrypted data stream, the control flags including synchronization flags and an encryption enable flag.

6. The method of claim 5, further comprising parsing the first encrypted data stream in an upstream module to extract the control flags prior to receiving the first encrypted data stream in the cipher.

7. The method of claim 1, further comprising operating the cipher to encrypt a second data stream.

8. The method of claim 1, further comprising clock gating the cipher and the first state machine if an incoming data stream is not encrypted.

9. An apparatus comprising:
a cipher to receive and decrypt encrypted data streams;
a first state machine coupled to the cipher to control the cipher to decrypt a first encrypted data stream associated with the first state machine, wherein the first state machine is to receive parsed information indicative of a type of encryption of the first encrypted data stream; and
a second state machine coupled to the cipher to control the cipher to authenticate the apparatus, wherein the second state machine is to receive parsed information from a source device that requests the authentication.

10. The apparatus of claim 9, further comprising a third state machine coupled to the cipher to control the cipher to decrypt a second encrypted data stream associated with the third state machine, wherein the third state machine is to receive parsed information indicative of a type of encryption of the second encrypted data stream, the cipher comprising a common cipher to receive and decrypt the first encrypted data stream and the second encrypted data stream.

11. The apparatus of claim 10, further comprising a multiplexer to receive the first and second encrypted data streams and select one of the first or second encrypted data streams to provide to the common cipher.

12. The apparatus of claim 9, wherein the first state machine comprises at least one encryption status signaling control state machine and the second state machine comprises an authentication state machine.

13. The apparatus of claim 10, wherein the common cipher is to be clocked at a higher bandwidth than the first and third state machines, and wherein the common cipher is to be clock gated if an unencrypted data stream is received.

14. The apparatus of claim 9, wherein the apparatus comprises a sink device and the cipher is reusable in devices of a product line including at least one of a source device or a repeater device.

15. The apparatus of claim 9, further comprising an upstream logic to receive the encrypted data streams and parse the parsed information therefrom.
